(19) United States
(12) Patent Application Publication
(10) Pub. No.: US 2020/0238210 A1
(43) Pub. Date: Jul. 30, 2020

(54) DUCT FILTER BOX

(71) Applicant: Santos Gonzalez, Newnan, GA (US)

(72) Inventor: Santos Gonzalez, Newnan, GA (US)

(21) Appl. No.: 16/680,149

(22) Filed: Nov. 11, 2019

Related U.S. Application Data
(63) Continuation-in-part of application No. 16/258,660, filed on Jan. 27, 2019.

(51) Int. Cl. B01D 46/00; B01D 46/10; F24F 13/08

(52) U.S. Cl. CPC B01D 46/0006; B01D 2279/50; F24F 13/085; B01D 46/10

(57) ABSTRACT

A duct filter box device including a filter box member and a duct collar member. The filter box member is in fluid communication with a supply air passage from an air handler unit. Moreover, the filter box member includes at least one filter element for filtering air particles from the supply air. The duct collar member is attached to the filter box member and is in fluid communication with the filtered supply air passing through the filter element. The duct collar member is attached to a supply duct channel for distributing the filtered air to one or more supply vents.

### CROSS-REFERENCE TO RELATED APPLICATION

This application is a continuation-in-part of pending U.S. Non-Provisional application Ser. No. 16/258,660 filed on Jan. 27, 2019, the disclosure of which is incorporated herein by reference in its entirety.

### FIELD OF THE INVENTION

Embodiments described herein generally relate to centralized air systems, and more particularly to filtering centralized air systems.

### BACKGROUND OF THE INVENTION

Dust and debris in a home air filter restrict air flow, which forces the furnace to strain and use more energy to heat or cool the home. Just like replacing a car engine's oil and air filter every 3,000 miles, a clean HVAC air filter protects the furnace system from becoming damaged and, ultimately, failing entirely. When conventional air filters are clogged, the air handler has to work harder in order to compensate for the blockage of air flow. Hence, an improved air filtration system is desirable to preserve the lifeline of the air handler unit.

### BRIEF DESCRIPTION OF THE DRAWINGS

The various advantages of the embodiments of the present disclosure will become apparent to one skilled in the art by reading the following specification and appended claims, and by referencing the following drawings, in which:

FIG. 1A shows an exemplary view of a duct filter box according to an embodiment of the present disclosure.

FIG. 1B shows an exemplary side view of the duct filter box according to an embodiment of the present disclosure.

FIG. 2 shows another exemplary view of the duct filter box according to an embodiment of the present disclosure.

### SUMMARY OF THE INVENTION

Exemplary embodiments disclosed herein describe a duct filter box device. The device includes a filter box member which may be mounted in fluid communication with a supply air passage from an air handler unit. The filter box member includes a filter enclosed in the filter box for filtering air particles from the supply air passing through the filter. The device also includes a duct collar member which is attached to a rear side of the filter box member. The duct collar member may be mounted in fluid communication with the filtered supply air passage from the air handler unit. The duct collar member may be attached to a supply duct in order to pass the filtered supply air through the supply duct.

In some exemplary embodiments, the filter box member includes a front frame element and a rear frame element.

In some exemplary embodiments, the rear frame element includes a pull-out enclosure for receiving the filter element.

In some exemplary embodiments, the filter element is a HVAC filter.

In some exemplary embodiments, the filter box is galvanized.

In some exemplary embodiments, the duct collar member is attached to a supply duct for distributing the filtered air to one or more supply vents.

### DETAILED DESCRIPTION

The present disclosure relates to a duct filter box device. In conventional HVAC systems, air supplied from an air handler system is distributed through a duct system to a supply vent and an air filter is used to filter the return air. The disclosed duct filter box device filters the air supplied from the air handler unit using a supply air filter enclosed in a filter box. The duct filter box can be retrofitted to conventional centralized air systems by replacing the traditional duct collar with the disclosed duct filter box device. The device can be used for residential and commercial establishments.

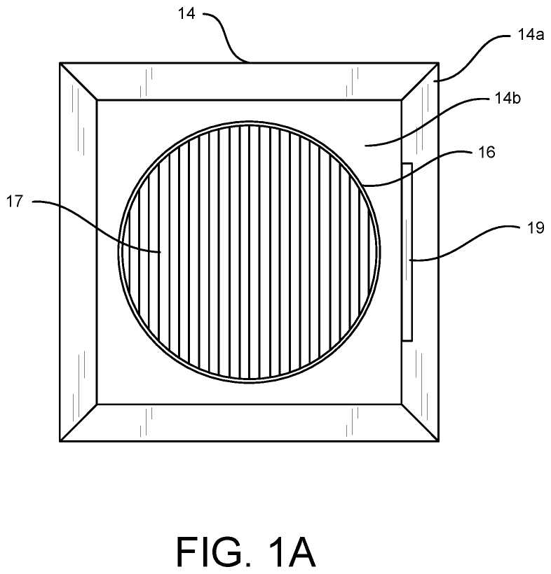

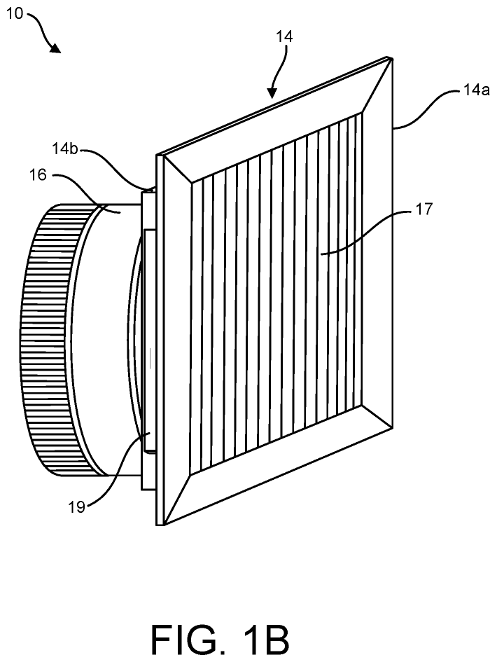

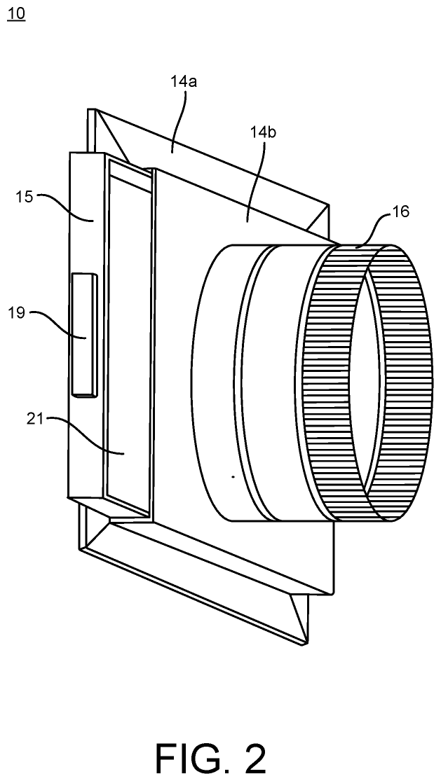

As illustrated in FIGS. 1A, 1B and 2, the duct filter box device (“the device”) 10 may include a filter box member 14 (i.e., 14a and 14b) and a duct collar member 16. The filter box member 14 may receive air from a supply air source (e.g., air handler unit) (not shown). The filter box member 14 includes a front frame element 14a and a rear frame element 14b, which are attached to one another thereby collectively forming an enclosure therebetween. In various embodiments, the front frame element is fixedly attached to the rear frame element. The front frame element 14a may be attached directly to the output of an air handler unit. The rear frame element 14b may include a pull-out filter unit 15 which may be slideably inserted into the enclosure formed by the front frame element 14a and the rear frame element 14b. The pull-out filter unit 15 includes a hollow shell 21 to receive a filter element 17 and includes a handle 19, which allows an individual to pull out the filter unit 15 to replace the filter element 17 in the filter box member 14.

The filter box member 14 may be made from any suitable material, such as, for example, steel or iron. In a preferred embodiment, the filter box member is galvanized. The filter element 17 is enclosed in the filter box member to filter air particles from the air passing through. The air particles may include, for example, dust from the supply air supplied from the air handler unit. The filter element 17 may be any suitable filter, such as, for example, HVAC, fiberglass filter, polyester and pleated filters, high efficiency particulate arrestance (HEPA) filters, etc.

The duct collar member 16 may be attached to the rear frame element 14b of filter box member 14. In various embodiments, the duct collar member is fixedly attached to the filter box member. The duct collar member may be mounted in fluid communication with the filtered supply air passing through filter element 17. The duct collar member may be attached to a supply duct channel for distributing the filtered air to one or more supply vents. The duct collar member may be made from any suitable material, such as, for example, steel or iron, and in a preferred embodiment, the duct collar is galvanized.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.)

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. A duct filter box device comprising:
a filter box member in fluid communication with a supply air passage from an air handler unit, the filter box member including at least one filter element for filtering air particles from the supply air; and
a duct collar member attached to the filter box member, wherein the duct collar member is in fluid communication with the filtered supply air passing through the filter element.

2. The device of claim 1, wherein the filter box member includes a front frame element and a rear frame element.

3. The device of claim 2, wherein the rear frame element includes a pull-out unit for receiving the filter element.

4. The device of claim 1, wherein the filter element is a HVAC filter.

5. The device of claim 1, wherein the filter box member is galvanized.

6. The device of claim 1, wherein the duct collar member is attached to a supply duct channel for distributing the filtered air to one or more supply vents.
